(19) United States
(12) Patent Application Publication
(10) Pub. No.: US 2006/0066548 A1
(43) Pub. Date: Mar. 30, 2006

(54) Sample-and-hold circuit and driver circuit

(75) Inventors: Teru Yoneyama, Kanagawa (JP); Yoshiharu Hashimoto, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/221,890

(22) Filed: Sep. 9, 2005

(30) Foreign Application Priority Data
Sep. 29, 2004 (JP) 2004-283342

(51) Int. Cl. G09G 3/36

(52) U.S. Cl. 345/89

(57) ABSTRACT

A sample-and-hold circuit according to the present invention includes an amplifier circuit amplifying a signal from an input terminal to output the amplified signal to an output terminal, a first switch connected to the input terminal, and a second switch arranged in parallel to the first switch and connected to the input terminal. Hence, an amplifier circuit operable at high speeds can be provided. In addition, a driver circuit for applying a grayscale voltage to each signal line of a display device includes a grayscale voltage output unit outputting a grayscale voltage, a precharge voltage generating unit generating a precharge voltage for a predetermined period before scanning, at a time of displaying on the display device, and an amplifier circuit amplifying an input signal to output the amplified signal to the display device.

### BACKGROUND OF THE INVENTION

1. Field of the Invention

The present invention relates to a sample-and-hold circuit and a driver circuit.

2. Description of Related Art

In general, a liquid crystal display device or other such display devices include a display panel for displaying an image, and a controller LSI for driving the display panel. The controller LSI includes a power supply circuit for supplying power voltage for driving the display panel, a driver circuit for driving the display panel in accordance with the output voltage from the power supply circuit, and the like. Provided in the driver circuit are a grayscale voltage generator circuit, a grayscale voltage selecting circuit for selecting one grayscale voltage level corresponding to display data from among plural levels of grayscale voltage generated in the grayscale voltage generator circuit, an amplifier circuit for amplifying a voltage to be used for driving the display panel, in accordance with the selected grayscale voltage level, and the like.

In controlling a grayscale in the display device, the above-mentioned controller LSI converts display data to change its grayscale characteristics. In the driver circuit of the display device, the grayscale voltage is generated by dividing an externally-applied reference voltage by means of a voltage-divider circuit such as a resistor.

In recent years, a display device such as a liquid crystal display device has been expected to finely and naturally display an image with a view to displaying a moving image or natural image through TV broadcast or DVD playback. In order to display a high-quality image, multi-grayscale and high-speed operation have been required of the driver circuit. The number of gray levels is increased to meet such a demand for multi-grayscale, more voltage supply lines, voltage-divider circuits, and decoder circuits are required, resulting in an enlarged chip area. To that end, a variety of methods have been proposed for reducing a chip area of the driver circuit. Japanese Patent No. 3302254 corresponding to U.S. Pat. No. 5,784,041 discloses a driver circuit for dividing input data into higher-order bits and lower-order bits, and generating two levels of interpolating voltage using the higher-order bits and dividing the interpolating voltages using the lower-order bits to thereby generate a desired output voltage.

In addition, a higher-resolution display panel has been under development in response to a need to enlarge the display panel. Hence, the number of scanning (scanning lines) in one frame is increased leading to a shorter write time per scanning. The shorter write time leads to insufficient application of a write voltage to a display pixel, and significant degradation of display characteristics. To solve such a problem, Japanese Unexamined Patent Publication No. 2001-166741 discloses a liquid crystal display device in which a precharge circuit is provided between a grayscale selecting circuit and an amplifier circuit to overcome a problem about insufficient application of a write voltage to each pixel.

FIG. 17 shows the configuration of the driver circuit of a liquid crystal display device as disclosed in Japanese Patent No. 3302254. FIG. 17 shows the configuration of a driver circuit 10 adapted to an 8-bit digital signal. The driver circuit 10 includes two voltage-divider circuits 1, 3 and two logic circuits 2, 4. The voltage-divider circuit 1 divides 9 externally-applied grayscale voltages V0, V32, . . . , and V256 to generate 24 interpolating voltages. In short, the voltage-divider circuit 1 generates 33 voltages in total, inclusive of the grayscale voltages and the interpolating voltages. The voltages generated in the voltage-divider circuit 1 are supplied to analog switches ASW0, ASW8, ASW16, . . . , and ASW248, and analog switches ASW0′, ASW8′, ASW16′, . . . , and ASW248′, respectively.

The logic circuit 2 selects one of 32 control signals S0, S8, S16, . . . , and S248, and selects one of 32 control signals S0′, S8′, S16′, . . . , and S248′ in accordance with values of upper 5 bits out of 8-bit digital data. The control signals S0, S8, S16, . . . , S248 are supplied to the analog switches ASW0, ASW8, ASW16, . . . , and ASW248, respectively. The control signals S0′, S8′, S16′, . . . , and S248′ are supplied to the analog switches S0′, S8′, S16′, . . . , and S248′, respectively. These analog switches are so structured as to turn on in accordance with input control signals.

As shown in FIG. 18, the voltage-divider circuit 3 divides voltages applied across 8 resistors “r” connected in series. The voltage of a node P0 is equivalent to a voltage supplied from the voltage-divider circuit 1 of FIG. 17 and selected by the analog switches ASW. The logic circuit 4 receives data of lower 3 bits out of the 8-bit digital data, and activates any of 8 control signals t0 to t7 in accordance with the values of the lower 3 bits. The control signals t0 to t7 are supplied to analog switches ASWt0 to ASWt7, respectively, and turned on in accordance with input signals. The analog switches ASWt0 to ASWt7 are applied with 8 voltages divided in the voltage-divider circuit 2. The logic circuit 4 selects any one of the 8 voltages divided in the voltage-divider circuit 2 in accordance with the values of lower 3 bits of the digital data, and the selected voltage is output.

It has now been discovered that, as shown in FIG. 18, the analog switches ASW0, ASW8, ASW16, . . . , and ASW248, and the analog switches ASW0′, ASW8′, ASW16′, . . . , and ASW248′ have an on-resistance. The on-resistance of the analog switches ASW brings about voltage drop, leading to a problem in that a desired output voltage cannot be obtained.

In addition, the plural driver circuits 10 are provided in an 8-bit digital driver. In this case, as a measure for promoting circuit-sharing to downsize an overall circuit, plural output circuits composed of the logic circuits 2, 4 and the voltage-divider circuit 3 are provided, and the output circuits share the driver circuit 1. In this case, when all the output circuits select the same grayscale, a combined resistance value becomes small because the voltage-divider circuits 3 of all the output circuits are parallel-connected to the voltage-divider circuit 1. Assuming that 200 output circuits are provided, when all the output circuits select the same grayscale, a combined resistance value of the voltage-divider circuits 3 is equal to 1/200 of the resistance value of the voltage divider circuit 3. Although depending on the number of output circuits, the total resistance value of the voltage divider circuits 3 should be set several thousand times to several tens of thousands of times larger than a resistance value RAn (n is an integer) of the voltage-divider circuit 1.

As described above, the increase in resistance value of the voltage-divider circuit 3 leads to a larger time constant, with the result that the operation speed of the circuit falls. Further, as shown in FIG. 19, buffers 6 may be inserted between the analog switches and the voltage-divider circuit 3 to lower a resistance value of the voltage-divider circuit 3. However, this causes another problem about an error resulting from an offset of the buffers 6 and about an enlarged circuit.

### SUMMARY OF THE INVENTION

A sample-and-hold circuit according to the present invention includes an amplifier circuit amplifying a signal from an input terminal to output the amplified signal to an output terminal, a first switch connected to the input terminal, and a second switch arranged in parallel to the first switch and connected to the input terminal. Hence, an amplifier circuit operable at high speeds can be provided.

In addition, a driver circuit for applying a grayscale voltage to each of a plurality of signal lines of a display device includes a grayscale voltage output unit outputting a grayscale voltage, a precharge voltage generating unit generating a precharge voltage for a predetermined period before scanning, at a time of displaying on the display device, and an amplifier circuit amplifying an input signal to output the amplified signal to the display device.

### BRIEF DESCRIPTION OF THE DRAWINGS

The above and other objects, advantages and features of the present invention will be more apparent from the following description taken in conjunction with the accompanying drawings, in which:

FIG. 1 is a circuit diagram showing a configuration example of a sample-and-hold circuit according to a first embodiment of the present invention;

FIG. 2 is a timing chart and an output waveform chart illustrating an operation of a sample-and-hold circuit;

FIG. 3 is a timing chart and an output waveform chart illustrating an operation of the sample-and-hold circuit according to the first embodiment;

FIG. 4A shows a capacitor array type D/A converter according to a second embodiment of the present invention, and FIG. 4B shows a switching element used in the D/A converter according to the second embodiment;

FIG. 5 is a circuit diagram showing a configuration example of a driver circuit according to a third embodiment of the present invention;

FIG. 6 is a circuit diagram illustrating an operation of the driver circuit according to the third embodiment;

FIG. 7 is an output waveform chart showing output waveforms of a conventional driver circuit;

FIG. 8 is a timing chart showing an operation of the driver circuit according to the third embodiment, and an output waveform chart thereof;

FIG. 9 is a circuit diagram showing a driver circuit according to a fourth embodiment of the present invention;

FIG. 10 is a timing chart showing an operation of the driver circuit according to the fourth embodiment, and an output waveform chart thereof;

FIG. 11 is a circuit diagram illustrating an operation of the driver circuit according to the fourth embodiment;

FIG. 12A is a circuit diagram showing a voltage-divider circuit of FIG. 11, and FIG. 12B is a circuit diagram showing another voltage-divider circuit of FIG. 11;

FIG. 13 is a circuit diagram showing a driver circuit according to a sixth embodiment of the present invention;

FIG. 14 is a circuit diagram showing a configuration example of an offset cancellation amplifier;

FIG. 15 is a timing chart and an output waveform chart illustrating an operation of the offset cancellation amplifier;

FIG. 16 is a circuit diagram showing another configuration example of the offset cancellation amplifier;

FIG. 17 is a circuit diagram showing the configuration of a conventional driver circuit;

FIG. 18 is a circuit diagram illustrative of a problem inherent in the conventional driver circuit; and

FIG. 19 is a circuit diagram showing another configuration of the conventional driver circuit.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment of the Invention

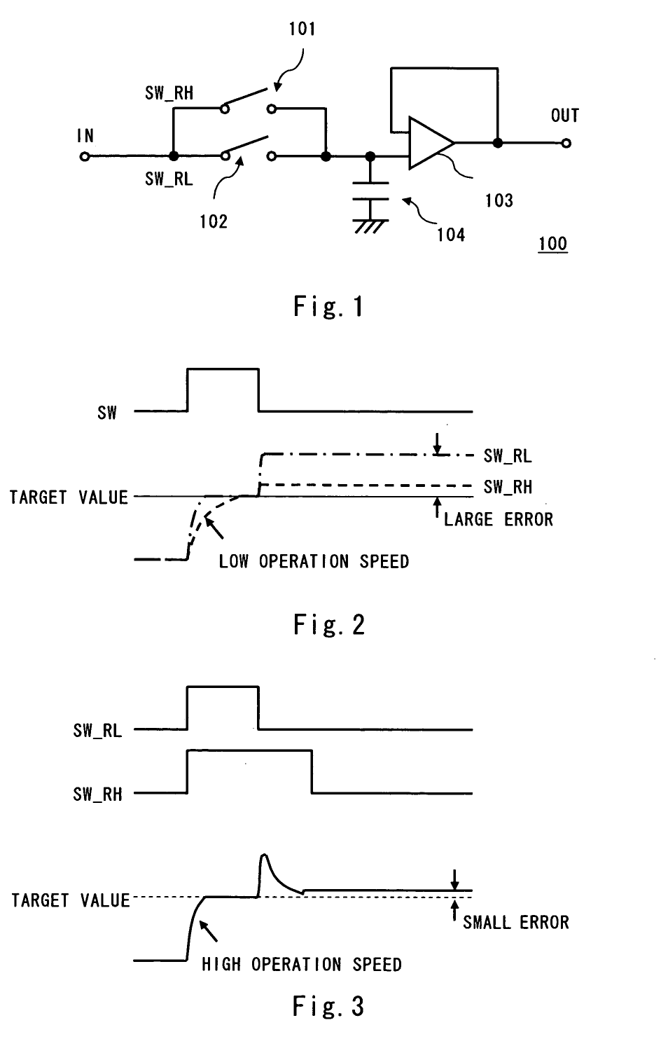

Referring now to FIG. 1, a sample-and-hold circuit according to a first embodiment of the present invention is described. FIG. 1 is a circuit diagram showing a sample-and-hold circuit 100 according to this embodiment. As shown in FIG. 1, the sample-and-hold circuit 100 includes a first analog switch 101 (SW_RH), a second analog switch 101 (SW_RL), and a differential amplifier 103. An impedance of the analog switch 101 is higher than that of the analog switch 102. The analog switches 101 and 102 are connected in parallel to a first input terminal of the differential amplifier 103. Note that FIG. 1 shows a capacitance 104; the capacitance 104 may assume a parasitic capacitance.

Referring now to FIGS. 2 and 3, the operation of the sample-and-hold circuit 100 is described. FIGS. 2 and 3 are timing charts and output waveform charts illustrative of a sampling operation of the sample-and-hold circuit 100. FIG. 2 shows the case where either the analog switch 101 (SW_RH) of a higher impedance or the analog switch 102 (SW_RL) of a lower impedance is used alone. Meanwhile, FIG. 3 is a timing chart and an output waveform chart illustrative of a circuit operation in the case of using both the analog switch 101 of a higher impedance and the analog switch 102 of a lower impedance.

In the case of manufacturing the analog switches 101 and 102 using a semiconductor manufacturing apparatus, it is preferable that the relation between a gate length (L1) of a transistor forming the analog switch 101 of a higher impedance and a gate length (L2) of a transistor forming the analog switch 102 of a lower impedance, and the relation between a gate width (W1) for the analog switch 101 and a gate width (W2) for the analog switch 102 satisfy the equations of, for example, L1=L2 and W1<W2, respectively.

As shown in FIG. 2, when sampling is carried out using the analog switch 102 (SW_RL) of a lower impedance solely, a high-speed operation can be made in response to a rising edge of a pulse. However, this case involves larger output noise, and thus fails to obtain a desired output value (as indicated by the dashed line of FIG. 2). In contrast, when sampling is carried out using the analog switch 101 (SW_RH) of a higher impedance, the output noise is small, and thus an output value near the desired value can be attained. However, the response to the riding edge of a pulse is slow (as indicated by the broken line of FIG. 3). The level of output noise increases in proportion to the gate width (W) of the transistor forming each switch, so the noise level of the analog switch 102 (SW_RL) of a lower impedance is higher than the other.

In this embodiment, as shown in FIG. 3, the analog switch 101 (SW_RH) of a higher impedance and the analog switch 102 (SW_RL) of a lower impedance are simultaneously turned on during an initial period of the sampling. The analog switch 101 (SW_RH) of a higher impedance and the analog switch 102 (SW_RL) of a lower impedance are parallel-connected, and hence the total combined resistance value of the switches becomes smaller. As a result, the high-speed operation can be made in accordance with the rising edge of a pulse.

After the initial period, the analog switch 102 (SW_RL) of a lower impedance is turned off, followed by turn-off of the analog switch 101 (SW_RH) of a higher impedance. Namely, the analog switch 101 of a higher impedance is turned off after turning off the analog switch 102 of a lower impedance. With this configuration, the noise can be reduced, and an accurate output value can be obtained.

### Second Embodiment of the Invention

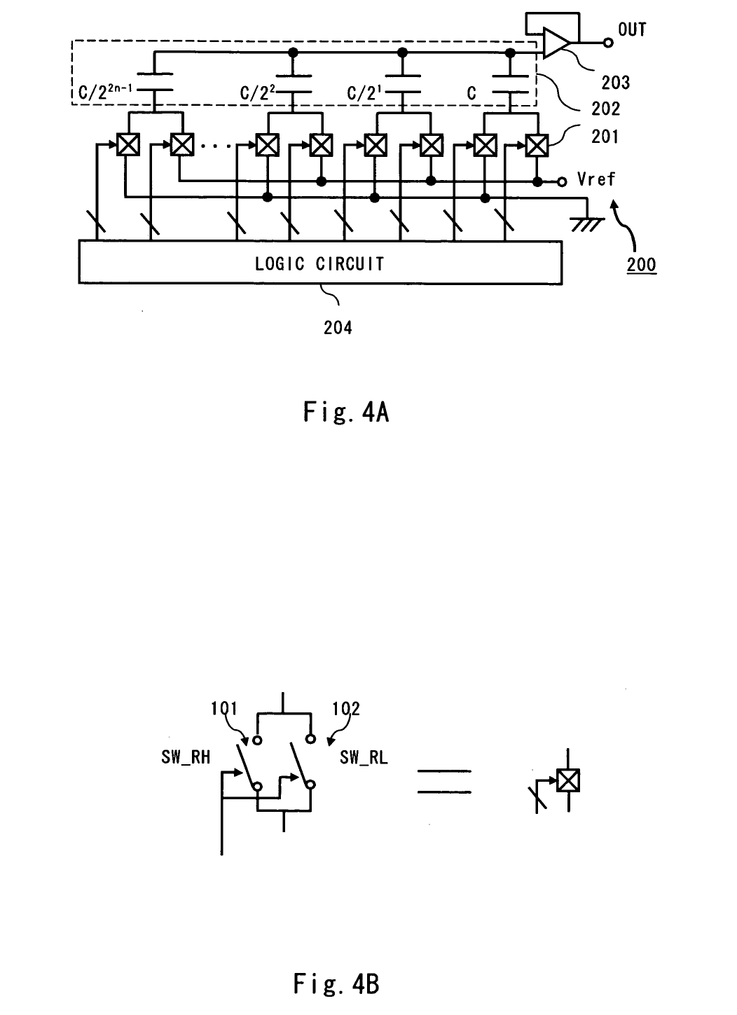

Referring to FIGS. 4A and 4B, a second embodiment of the present invention is described. FIG. 4A shows a capacitor array type D/A converter 200, and FIG. 4B shows a switching element 201 used in the D/A converter 200. The second embodiment describes an example of the capacitor array type D/A converter 200 using the switching element 201 in which the analog switch 101 (SW_RH) of a higher impedance and the analog switch 102 (SW_RL) of a lower impedance are parallel-connected, as shown in FIG. 4B. The D/A converter 200 converts input data to analog voltage.

As shown in FIG. 4A, the D/A converter 200 includes a capacitor array 202, and an output buffer 203 having an operational amplifier etc. and connected to an output line of the capacitor array 202. The capacitor array 202 includes 2n capacitors (condensers) the capacitances of which are set to c, c/2¹, c/2², . . . , and c/2²ⁿ⁻¹, respectively in accordance with the bit number of the input data.

Further, the D/A converter 200 is provided with the switching elements 201 used for converting the input data into analog voltage by means of the capacitor array 202. The second embodiment shows the switching element 201 in which the two analog switches of different impedance levels as described in the first embodiment are parallel-connected.

One ends of the condensers in the capacitor array 202 are respectively connected to a reference voltage line transmitting a reference voltage Vref, and a GND line (one of power source lines). The reference voltage line and the GND line are connected to the capacitor array 202 alternatively through the switching elements 201. The other ends of the condensers are respectively connected to the output line for outputting the divided reference voltage Vref.

Here, the operation of the D/A converter 200 thus structured is described. First, the capacitor array 202 is connected to GND to discharge accumulated charges in each condenser. Then, the switching elements 201 are switched between the GND line and the reference voltage line in accordance with each bit value of input data from the logic circuit 204. For example, the following operation is carried out. If the most significant bit (MSB) of the input data is “0”, the switching element 201 connected to a condenser of the largest capacitance is switched to the GND line. If the least significant bit of the input data is “1”, the switching element 201 connected to a condenser of the smallest capacitance is switched to the reference voltage line (Vref). With this operation, a voltage divided on the basis of the input data is applied to the output line connected to the other ends of the respective condensers.

As described above, the analog switch 101 (SW_RH) of a higher impedance and the analog switch 102 (SW_RL) of a lower impedance are concurrently turned on during a predetermined period of time, and thus the high-speed operation can be performed. In the case where the switches are turned off thereafter, the analog switch 102 (SW_RL) of the lower impedance is turned off before the analog switch 101 (SW_RH) of the higher impedance is turned off. With this operation, an accurate output value can be attained. The output value is supplied through the output buffer 203, so a desired output can be obtained.

### Third Embodiment of the Invention

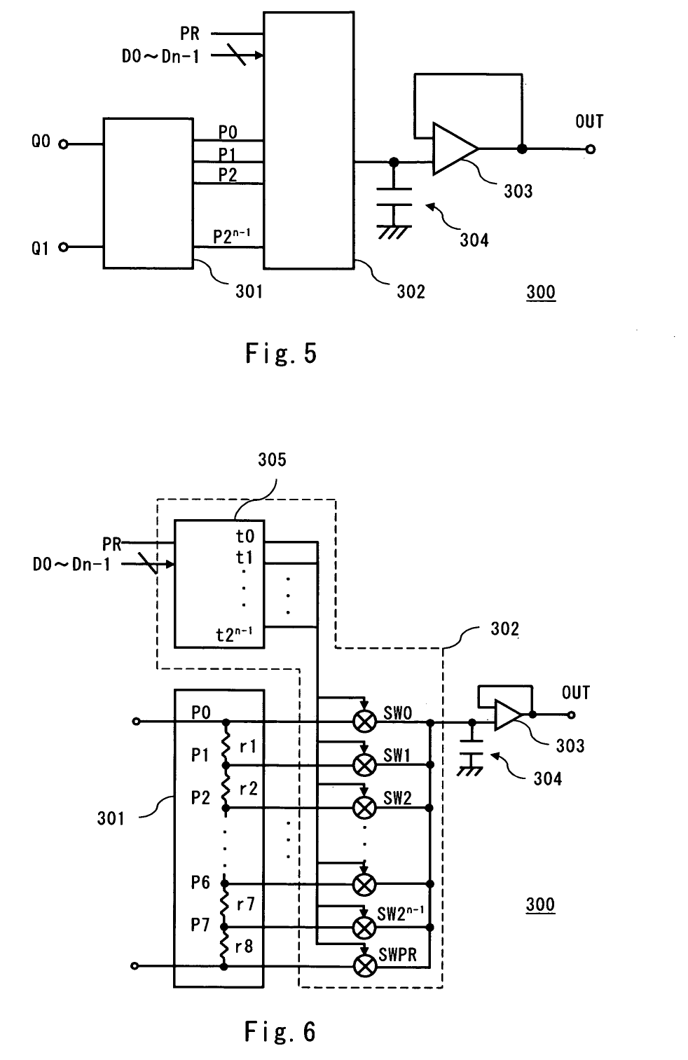

Referring to FIG. 5, a third embodiment of the present invention is described. FIG. 5 is a circuit diagram showing a driver circuit 300 provided with a precharge circuit. As shown in FIG. 5, the driver circuit 300 includes a voltage-divider circuit 301, a decoder 302, and an output buffer 303. In the illustrated example, a condenser 304 is inserted between the decoder 302 and the output buffer 303; the condenser may be a parasitic capacitance. In addition, the decoder 302 is provided with a precharge circuit (not shown) for charging the condenser 304 provided between the decoder 302 and the output buffer 303.

The voltage-divider circuit 301 generates 2n grayscale voltages based on input signal voltages Q0, Q1 (Q0<Q1) that are externally applied. In the illustrate example, the two input signal voltages are externally applied. However, the present invention is not limited thereto, and two or more voltages may be externally applied. The grayscale voltages generated in the voltage-divider circuit 301 are supplied to the decoder 302, and then a desired voltage is output in accordance with n-bit digital data, through the output buffer 303.

Referring now to FIG. 6, an operation of the driver circuit 300 according to the third embodiment is described. FIG. 6 is a circuit diagram of the driver circuit 300 shown in FIG. 5. In the driver circuit 300, when a switch SW0 is selected based on digital signals D0 to Dn-1, the voltage Q0 (voltage of the node P0 in the voltage-divider circuit 301) is directly output. Further, when a switch SW1 is selected, a voltage obtained at the node P1 by way of a resistor r1 is output. When a switch SW2 is selected, a voltage obtained at the node P2 by way of the resistors r1, r2, is output. In this way, the number of resistors (resistance value) through to the output varies depending on the selected grayscale data.

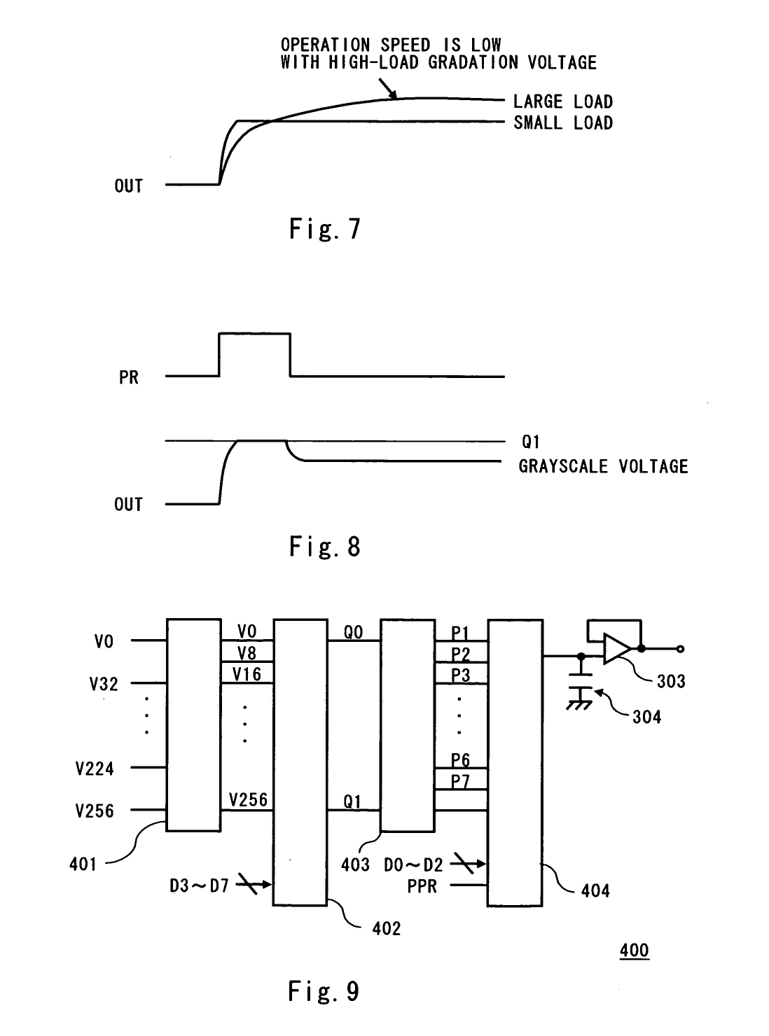

FIG. 7 is an output waveform chart in the case where the number of resistors (resistance value) through which the signal passes before output varies. As shown in FIG. 7, if the resistance value is large, a time constant (τ=CR) defined between the voltage-divider circuit 301 and the output buffer 303 becomes large, so the operation speed is lowered. To overcome such a drawback, the precharge circuit is provided in the decoder 302 for precharging up to around a target voltage in accordance with a precharge signal PR.

A display device such as liquid crystal display device scans (selects) each scanning line sequentially in each frame and provides grayscale signals to the pixels connected to the scanned (selected) scanning line through display lines. In this embodiment, the precharge operation is performed before scanning each scanning line of a display device. When the precharge signal PR is turned on, the switches SW0 to SW2ⁿ⁻¹ are turned off independently of an externally-supplied digital signal, and a switch SWPR is selected to thereby directly output the voltage Q1. The voltage Q1 is output not through any resistor, so a time constant is small. The charges (voltage Q1) can be accumulated in the condenser 304 at high speeds passing through any resistor. After that, the precharge signal PR is turned off, so a target grayscale voltage is attained.

FIG. 8 is a timing chart and an output waveform chart in the case of using the driver circuit 300 according to this embodiment. As shown in FIG. 8, the circuit operates at high speeds in response to a rising edge of the precharge signal PR, and the charges (voltage Q1) are accumulated in the condenser 304. Then, the precharge signal PR is turned off, so a desired grayscale voltage can be attained.

For example, if the driver circuit 300 according to this embodiment is used for a liquid crystal display device, a writing operation to a pixel can be carried out at higher speeds, thereby solving the problem about inefficient writing.

### Fourth Embodiment of the Invention

Referring to FIG. 9, a fourth embodiment of the present invention is described. FIG. 9 shows the configuration of an 8-bit digital driver circuit 400. For example, a driver circuit disclosed in U.S. Pat. No. 5,784,041 can be used as the driver circuit 400 according to this embodiment, and the disclosure thereof is incorporated herein by reference. The driver circuit 400 includes a voltage-divider circuit 401, a decoder 402, a voltage-divider circuit 403, a decoder 404, and an output buffer 303. The decoder 404 is provided with the precharge circuit (not shown) used in the above third embodiment. In FIG. 9, the same components as those of FIG. 6 are denoted by like reference numerals.

The voltage-divider circuit 401 divides externally-applied 9 voltages V0, V32, . . . , and V256 to generate 33 grayscale voltages (V0, V8, V16, . . . , and V256). The decoder 402 receives data of upper 5 bits out of the 8-bit digital data, and selects two interpolating voltages in accordance with the values of upper 5 bits. The voltage-divider circuit 403 generates 8 grayscale voltages P0 to P7 based on the two interpolating voltages selected by the decoder 402. The grayscale voltages are applied to the decoder 404, and the decoder 404 outputs a desired voltage based on the data of lower 3 bits out of the 8-bit digital data. In the illustrate example, the condenser 304 is provided between the output buffer 303 and the decoder 404; the condenser may be a parasitic capacitor.

As explained above in connection with the related art, a resistance value of the voltage-divider circuit 403 is much larger than a resistance value of the voltage-divider circuit 401. Hence, the time constants defined between the voltage-divider circuit 403 and the buffer 303 through the decoder 404 are extremely large. This slows down the circuit operation. To overcome such a drawback, the precharge circuit provided to the decoder 404 is used. When the precharge signal PR is active, a precharge voltage PPR is selected regardless of the values of lower 3 bits (D0 to D2) out of the digital data. Hence, the voltage PPR near a target voltage can be stored in the capacitor. After that, the precharge signal PR is turned off to thereby attain the target output.

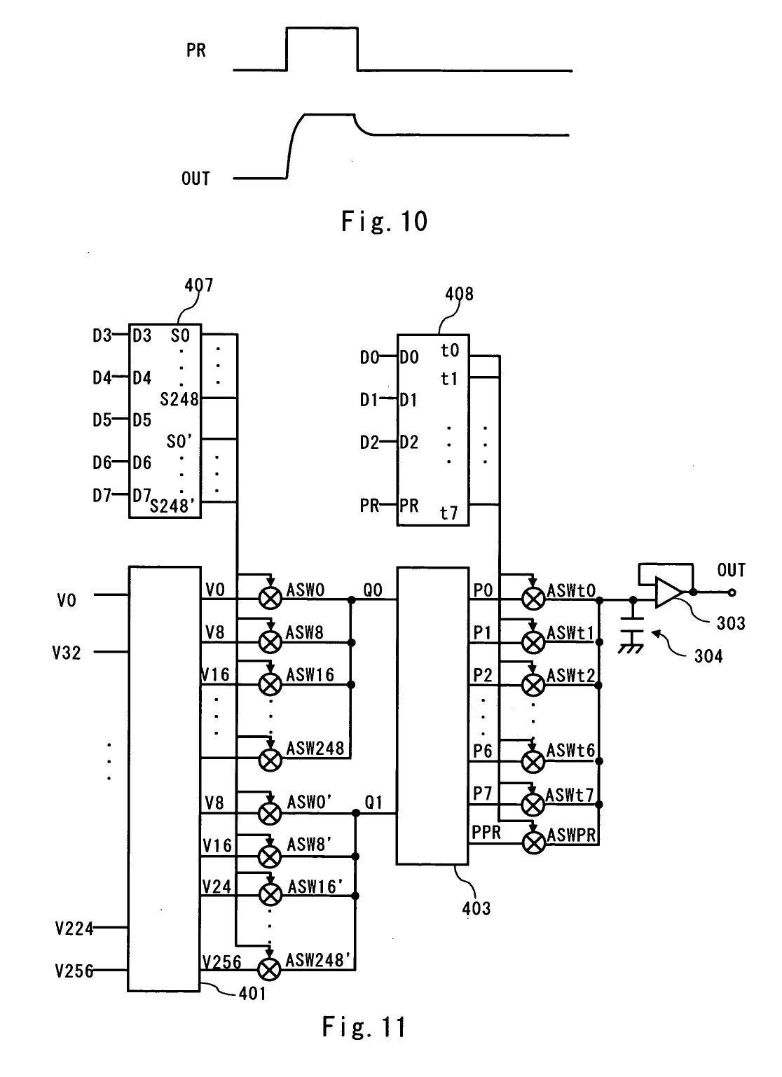

As shown in FIG. 10, the driver circuit 400 according to the fourth embodiment operates at high speeds in response to the rising edge of the precharge signal PR, after which the precharge signal PR is turned off to thereby obtain a desired value.

The precharge voltage PPR is equal to the voltage Q1. In other words, the voltage Q1 is output not through any resistor, namely, there is an on-resistance of a switch ASWPR alone. Thus, the high-speed operation is possible.

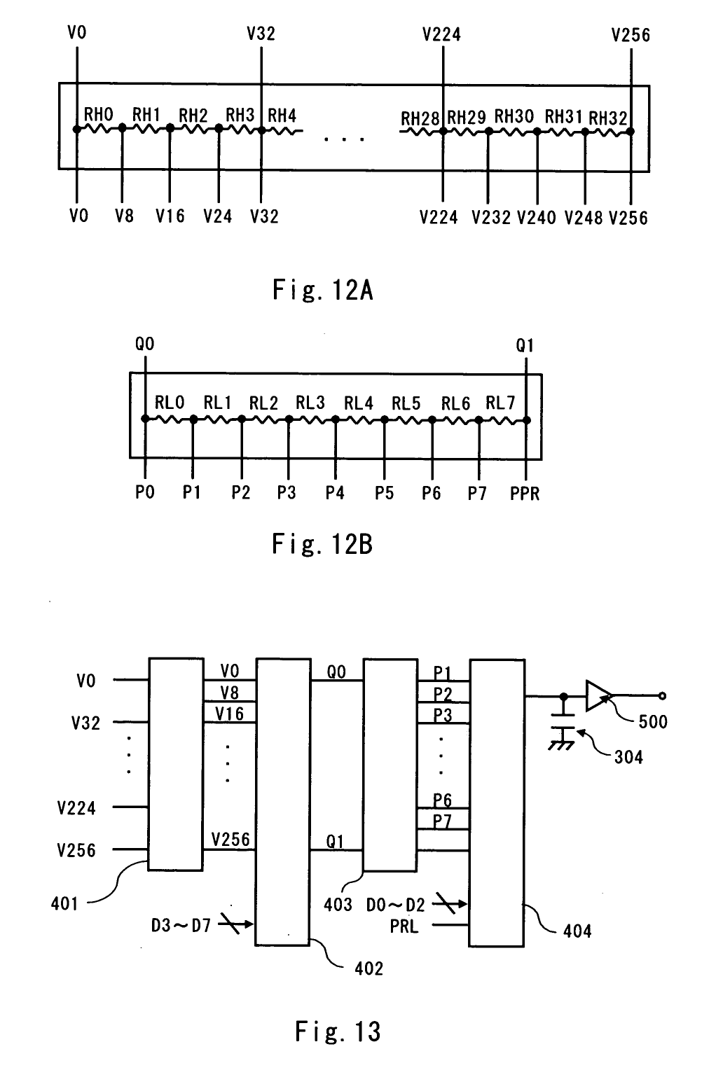

Referring to FIG. 11 and FIGS. 12A and 12B, the operation of the driver circuit 400 according to the fourth embodiment is described. FIG. 11 is a circuit diagram showing the driver circuit 400 according to this embodiment. FIG. 12A is a circuit diagram of the voltage-divider circuit 401 of FIG. 11, and FIG. 12B is a circuit diagram of the voltage-divider circuit 403 of FIG. 11. A logic circuit 407, and analog switches ASW0, ASW8, ASW16, . . . , and ASW248, and analog switches ASW0′, ASW8′, ASW16′, . . . , and ASW248′ are adapted to the decoder 402 of FIG. 9. A logic circuit 408, and analog switches ASWt0 to ASWt7, and ASWPR are adapted to the decoder 404 of FIG. 9.

It is assumed herein that the switch ASWt3 is selected, for example. If the switch ASWt3 is selected, a target voltage is output from the output buffer 303 by way of resistors RL0, RL1, and RL2, and the switch ASWt3. If the precharge signal PR is active, the analog switches ASWt0 to ASWt7 are all turned off, while the analog switch ASWPR is turned on. The analog switch ASWPR is directly applied with the voltage Q1. Hence, the potential of the voltage PPR (Q1) near the target voltage can be stored in the condenser 304 at high speeds without any influence from the voltage-divider circuit 404 of a high impedance. After that, the precharge signal PR is turned off to thereby output the voltage of the node P3 as the target voltage. In this way, a desired output value can be obtained at high speeds.

### Fifth Embodiment of the Invention

In the fourth embodiment of the present invention, precharging is carried out on the signal voltage Q1 even when the grayscale voltage close to the voltage Q0 is required. This involves a large loss. To that end, the driver circuit according to the fifth embodiment of the present invention determines the value of the precharge voltage based on the value of the grayscale voltage. Specifically, the present embodiment adopts the structure where it is determined whether precharging is carried out on the voltage Q0 or the voltage Q1, with reference to the most significant bit (MSB) of the digital signal (lower 3 bits) input to the decoder 404. In other words, if the precharge signal PR is activated, and the most significant bit (MSB) of the digital signal (lower 3 bits) input to the decoder 404 is “0”, the analog switches ASWt1 to ASWt7, and ASWPR are turned off, and the precharging is carried out using the voltage Q0 (voltage at the node P0).

On the other hand, if the signal PR is activated, and the most significant bit of the digital signal (lower 3 bits) input to the decoder 404 is “1”, the analog switches ASWt0 to ASWt7 are turned off, and the precharging is carried out using the voltage Q1 (PPR). In this way, the most significant bit (MSB) of the digital signal (lower 3bits) input to the decoder 404 is used to thereby enable an efficient operation.

### Sixth Embodiment of the Invention

Referring to FIG. 13, a driver circuit according to a sixth embodiment of the present invention is described. This embodiment describes an example of using an offset cancellation amplifier 500 as an output buffer of the driver circuit provided with the precharge circuit described in the fourth embodiment (FIG. 9). FIG. 13 is a circuit diagram of the driver circuit having the offset cancellation amplifier 500. In FIG. 13, the same components as those of FIG. 9 are denoted by like reference numerals, and their description is omitted here.

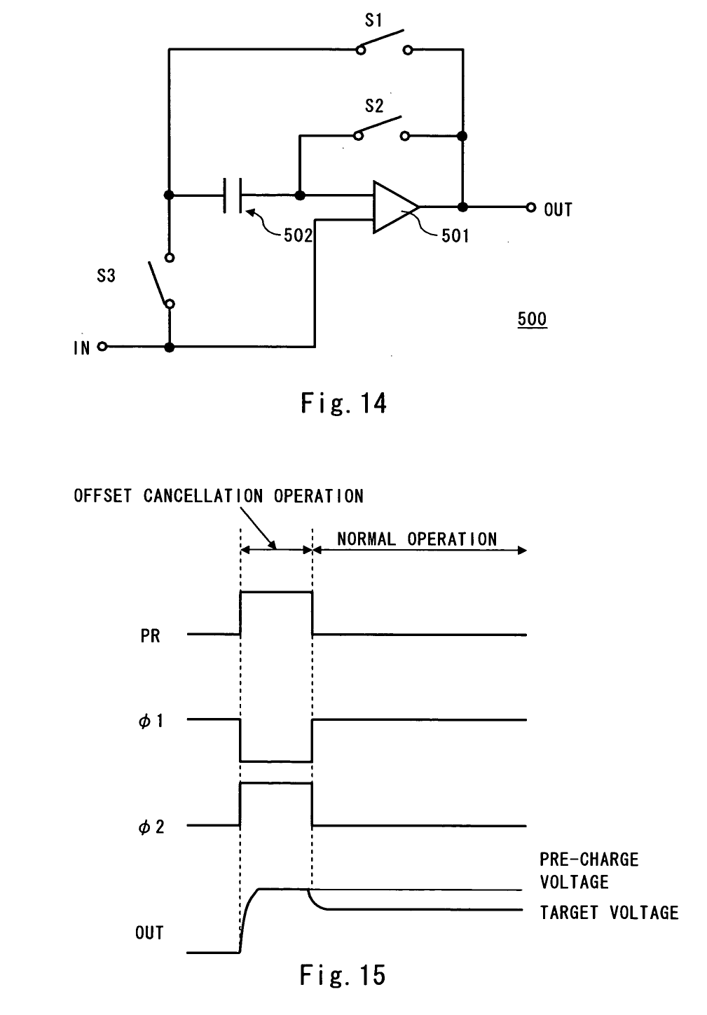

In the sixth embodiment, an amplifier having an offset cancellation function is used in place of the output buffer 303 of the driver circuit 400 illustrated in FIG. 9. Referring to FIG. 14, the offset cancellation amplifier 500 is described. FIG. 14 shows an example of the circuit configuration of the offset cancellation amplifier 500. Note that the offset cancellation amplifier 500 is not limited to this circuit configuration.

As shown in FIG. 14, the offset cancellation amplifier 500 includes an output buffer 501 composed of an operational amplifier, a condenser 501 (capacitance Coff), a switch S1 (clock φ1), a switch S2 (clock φ2), and a switch S3 (clock φ3). The input data is supplied through a first input terminal of the output buffer 501. The switch S2 (clock φ2) is connected between the output terminal and a second input terminal of the output buffer 501. Also, one end of the condenser 502 (capacitance Coff) is connected to the second input terminal of the buffer 501. The switch S1 (clock φ1) is connected between the other end of the condenser 502 and the output terminal of the buffer 501. Further, the switch S3 (clock φ2) is interposed and connected between the other end of the condenser 502 and the first input terminal of the buffer 501.

In a normal operation (voltage follower) state, the switch S1 (clock φ1) is turned on, and the switch S2 (clock φ2) and the switch S3 (clock φ2) are turned off. Under the normal operation, the voltage applied to the first input terminal of the output buffer 501 is output. In an offset cancellation operation state, the switch S1 (clock φ1) is turned off, and the switch S2 (clock φ2) and the switch S3 (clock φ2) are turned on.

In general, the voltage applied to the first input terminal is output by means of the voltage follower composed of the output buffer 501 and the switch S2. However, the output buffer 501 involves an offset that would occur when manufactured by a semiconductor manufacturing apparatus. As a result, in practice, the voltage applied to the first input terminal of the output buffer 501 is not equal to the voltage output from the output buffer 501.

In this embodiment, the offset voltage is stored in the condenser 502 (capacitance Coff). The condenser 502 (capacitance Coff) is connected to the first input terminal (IN) of the output buffer 501 by means of the switch S3 and to the output terminal (OUT) of the output buffer 501 by means of the switch S2, and thus can store the offset voltage of the output buffer 501. Therefore, the input voltage (IN) can be output with accuracy under the normal operation (voltage follower) state.

However, the operational amplifier exhibits a dependency on an offset voltage. In other words, the offset voltage of the operational amplifier is changed along with a change in input voltage. Thus, if the voltage-divider circuit 403 has a higher impedance, it is necessary to wait for the voltage output from the decoder 404 to stabilize, in order to store a normal offset voltage value. Consequently, the operation of storing the offset voltage takes much time. In addition, in a circuit having many output buffers like a driving circuit for a display device, the offset voltage varies among the output buffers. If the offset cancellation operation is ended in such a state that the input voltage is still unstable, the offset voltages of each output buffer cannot be accurately stored, resulting in variation from output to output in the driving circuit.

To overcome such a drawback, the precharge signal PR is used to stabilize the voltage output from the decoder 404 at high speeds, and then the resultant voltage is used to store the offset cancellation voltage. The precharge signal PR is supplied not through any resistor, so the voltage output from the decoder 404 can be stabilized at high speeds. The operation amplifier exhibits the dependency on an offset voltage; however, this gives no adverse influences on the circuit operation since the precharge voltage is close to the target voltage.

Referring to FIG. 15, an operation of the offset cancellation amplifier 500 according to this embodiment is described. FIG. 15 is a timing chart and an output waveform chart. First, the precharge signal PR is turned on, and at the same time, the switch S1 (clock φ1) is turned off, and the switches S2 and S3 (clock φ2) are turned on. At this time, the offset cancellation operation is performed using the precharge voltage, and the offset voltage of the output buffer is stored in the condenser 502.

After that, the precharge signal PR is turned off, and at the same time, the switch S1 (clock φ1) is turned on, and the switches S2 and S3 are turned off. Hence, the offset cancellation amplifier 500 is put in a normal operation state, so the precharge function of the decoder is disabled, and the decoder outputs a target voltage. Hence, a desired output can be attained. With this setting, the high-speed operation is possible.

In the above description, the precharge signal PR and the control signal clock φ1 of the switch S1 are separately generated. However, the control signal clock φ1 of the switch S1 is an inverted signal of the precharge signal, so the control signal clock φ1 of the switch S1 can be easily generated from the precharge signal. Hence, a common signal can be utilized for the clock and the precharge signal. As for a display device driving circuit, a switch (not shown) is interposed between the output buffer and the display panel. The switch is used for changing signals to be sent from the driving circuit to the display panel. It is preferable that the offset cancellation operation be effected while this switch is turned off.

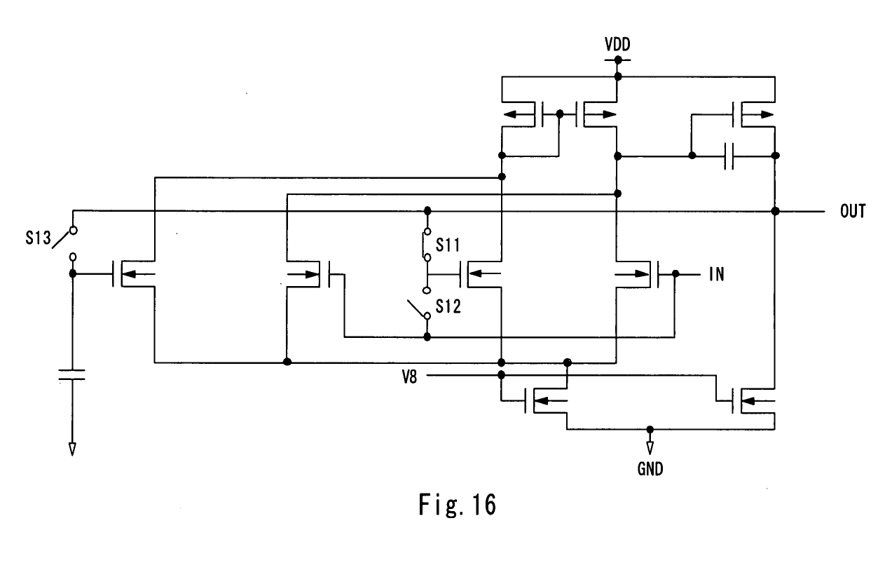

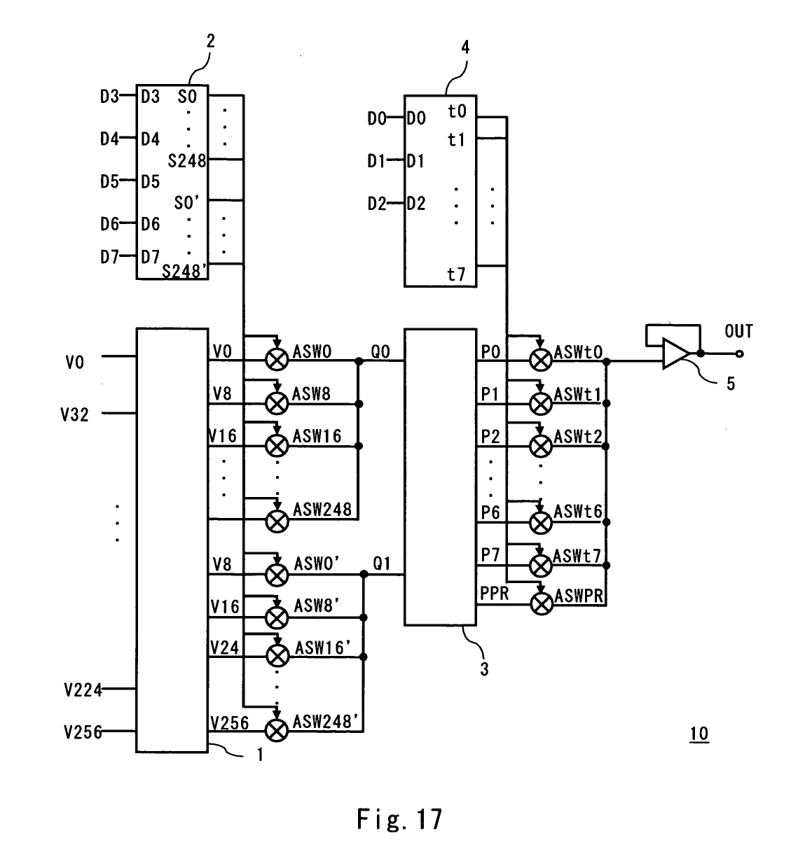

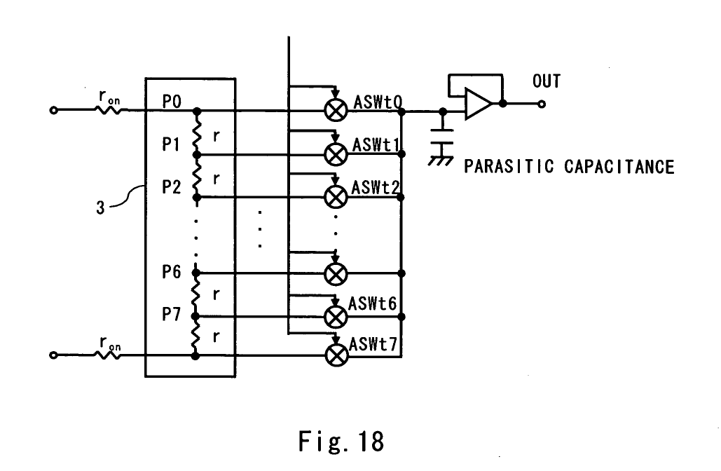

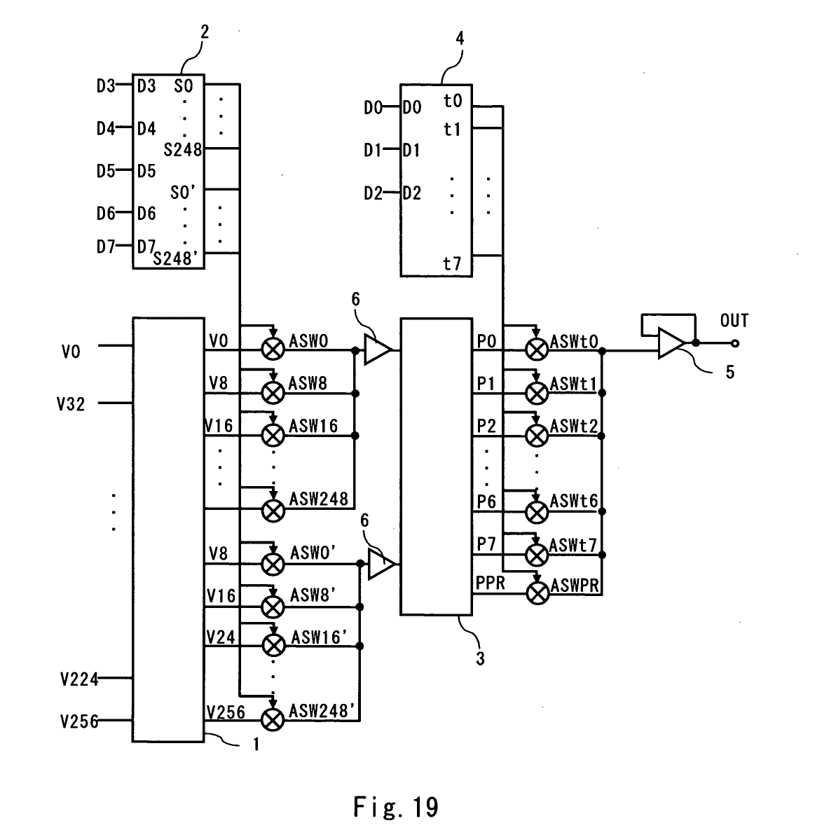

In addition, usable as the operational amplifier having an offset cancellation function is one structured as shown in FIG. 16. In the operational amplifier having the offset cancellation function as shown in FIG. 16, similar to the operation illustrated in FIG. 15, a switch S11 operates in response to a clock φ1, and switches S12 and S13 operate in response to a clock φ2. The state where the switch S11 (clock φ1) is turned on, and the switch S12 (clock φ2) and the switch S13 (clock φ2) are turned off refers to a normal operation (voltage follower) state. The state where the switch S11 (clock φ1) is turned off, and the switches S12 and S13 (clock φ2) are turned on refers to an offset cancellation operation state.

As regards the driver circuit, the aforementioned amplifier circuit 100, precharge circuit, and offset cancellation amplifier 500 may be separately or integrally provided. In addition, in the above example, the circuit is used in the capacitor array type DA converter. However, the present invention is not limited thereto. Besides, the driver circuit can be used as a driver circuit for driving a capacitive load of a liquid crystal display device, an organic EL display device, etc.

It is apparent that the present invention is not limited to the above embodiment that may be modified and changed without departing from the scope and spirit of the invention.

What is claimed is:

1. A sample-and-hold circuit, comprising:
a capacitance holding a sampled signal;
an amplifier circuit amplifying a signal from the capacitor to output the amplified signal;
a first switch and a second switch connected in parallel through both of which an input signal is applied to the capacitance during a predetermined period.

2. The sample-and-hold circuit according to claim 1, wherein sampling is carried out through the first switch and the second switch at an initial period of the sampling, and carried out through one of the first switch and the second switch after the initial period.

3. The sample-and-hold circuit according to claim 1, wherein the first switch has an impedance different from an impedance of the second switch.

4. The sample-and-hold circuit according to claim 1, wherein sampling is carried out through the first switch and the second switch at an initial period of the sampling, and carried out through one of the first switch and the second switch after the initial period, the one having a higher impedance than the other.

5. A driver circuit for applying a grayscale voltage to signal lines of a display device, comprising:
a grayscale-voltage output circuit outputting a grayscale voltage;
an amplifier circuit amplifying the grayscale voltage to output the amplified grayscale voltage to a display device; and
a precharge voltage generating circuit generating a precharge voltage for an input of the amplifier circuit before scanning each scanning line of the display device.

6. The driver circuit according to claim 5, wherein a value of the precharge voltage is determined based on a value of the grayscale voltage.

7. The driver circuit according to claim 5, wherein the amplifier circuit has an offset cancellation function.

8. The driver circuit according to claim 6, wherein the amplifier circuit has an offset cancellation function.

9. The driver circuit according to claim 7, wherein:
the amplifier circuit with the offset cancellation function includes:
an amplifier amplifying an input signal;
an offset voltage storage circuit storing an offset cancellation voltage; and
three switches, wherein
input data is supplied through a first input terminal of the amplifier;
a first switch is connected between a second input terminal and an output terminal of the amplifier;
the second input terminal is connected to one end of a capacitor;
a second switch is connected between the other end of the capacitor and the output terminal; and
a third switch is connected between the other end of the capacitor and the first input terminal.

10. The driver circuit according to claim 8, wherein:
the amplifier circuit with the offset cancellation function includes:
an amplifier amplifying an input signal;
an offset voltage storage circuit storing an offset cancellation voltage; and
three switches, wherein
input data is supplied through a first input terminal of the amplifier;
a first switch is connected between a second input terminal and an output terminal of the amplifier;
the second input terminal is connected to one end of a capacitor;
a second switch is connected between the other end of the capacitor and the output terminal; and
a third switch is connected between the other end of the capacitor and the first input terminal.

11. The driver circuit according to claim 9, wherein:
when the second switch is turned off, the first switch and the third switch are turned on to store an offset cancellation voltage; and
when the second switch is turned on, the first switch and the third switch are turned off to perform a normal operation.

12. The driver circuit according to claim 10, wherein:
when the second switch is turned off, the first switch and the third switch are turned on to store an offset cancellation voltage; and
when the second switch is turned on, the first switch and the third switch are turned off to perform a normal operation.

13. A driver circuit, comprising:
an input terminal applied with grayscale voltage;
a node;
an amplifier circuit provided between the node and an output terminal; and
a switch circuit provided between the input terminal and the node and including a first switch and a second switch, the switch circuit supplying charges to the node through the first switch and the second switch during a first period and supplying charges corresponding to a grayscale voltage to the node during a second period following the first period.

14. The driver circuit according to claim 13, wherein the first switch is turned on during the first period, and the second switch has an impedance higher than the first switch and is turned on during the first period and the second period.

15. The driver circuit according to claim 13, wherein the switch circuit includes:
a first switch group through which a reference voltage is provided to the node and including switches with different impedances; and
a second switch group through which a power supply voltage is provided to the node and including switches with different impedances.

16. The driver circuit according to claim 13, wherein an input signal voltage externally applied during the first period is supplied to the node without passing through a resistor element.

17. The driver circuit according to claim 16, wherein the amplifier circuit is an offset cancellation amplifier, and the offset cancellation amplifier carries out an offset cancellation operation during the first period.
